(19) United States
(12) Patent Application Publication
(10) Pub. No.: US 2006/0077499 A1
(43) Pub. Date: Apr. 13, 2006

(54) Scanner and distribution mechanism thereof

(75) Inventor: Chih-Wei Lu, Taipei County (TW)

Correspondence Address: BIRCH STEWART KOLASCH & BIRCH, PO BOX 747, FALLS CHURCH, VA, 22040-0747, US

(73) Assignee: BENQ CORPORATION

(21) Appl. No.: 11/227,132

(22) Filed: Sep. 16, 2005

(30) Foreign Application Priority Data
Sep. 16, 2004 (TW) 93127988

(51) Int. Cl. G02B 26/08

(52) U.S. Cl. 359/197

(57) ABSTRACT

A scanner and a distribution mechanism thereof. A rocker arm is pivoted on a frame to swing up to an upper dead point or down to a lower dead point. A first gear is pivoted on the first shaft, and a second gear is pivoted on the second gear, engaging the first gear. A friction element (a woolpad wheel) is pivoted on the rocker arm and abuts the second gear and the rocker arm. When the first gear rotates the second gear, the second gear rotates the rocker arm upward or downward selectively via the friction element, and when the rocker arm swings up to the upper dead point or down to the lower dead point, the second gear maintains rotation of the friction element with respect to the rocker arm.

### BACKGROUND

The invention relates to a distribution mechanism for scanned objects in a scanner, and in particular to a distribution mechanism with a friction element, wherein when a trail loading a scanned object swings to an upper or a lower dead point, force driving the trail can be released therefrom via the friction element.

There are currently two main types of film scanners on the market. One is provided with a film cartridge. When a scan procedure is performed, a film is placed in the film cartridge and the film cartridge is pushed into the film scanner. The other is provided with a feed opening. When a scan procedure is performed, a film is manually inserted into the opening. The structure of the film scanner with feed opening is shown in FIG. 1. A film F is inserted into a feed opening (not shown) of a film scanner 100 and enters a scan module 30 via a trail 10 and a track 20. A draw mechanism (not shown) disposed in the scan module 30 is driven by a motor 50 and a plurality of engaged gears 60 (for simplicity, gears are illustrated as wheels in each figure) on a frame 40 to draw the film F into the scan module 30. When the film scan is complete, the motor 50 reverses and ejects the film F via the feed opening.

If only one film is scanned, the described structure can easily accomplish the film scanning process. If several films are intended to be scanned and fed into the scanner at the same time, the ejected films which are already scanned may be mixed with the films about to be fed. This causes repeated scans. To avoid this, the films must be manually fed one by one to prevent repeated scans, which is inconvenient and time consuming.

### SUMMARY

A distribution mechanism for a scanned object according to an embodiment of the invention comprises a frame, a rocker arm pivoted on the frame and capable of swinging up to an upper dead point or down to a lower dead point, a first gear is pivoted on the frame, a second gear pivoted on the rocker arm and engages the first gear, and a friction element is pivoted on the rocker arm abutting the second gear and the rocker arm, wherein when the first gear rotates the second gear, the second gear rotates the rocker arm upward or downward selectively via the friction element, and when the rocker arm swings up to the upper dead point or down to the lower dead point, the second gear maintains rotation of the friction element with respect to the rocker arm.

### BRIEF DESCRIPTION OF THE DRAWINGS

The invention can be more fully understood by reading the subsequent detailed description and examples with references made to the accompanying drawings, wherein:

FIG. 1 is a perspective view of a conventional scanner;

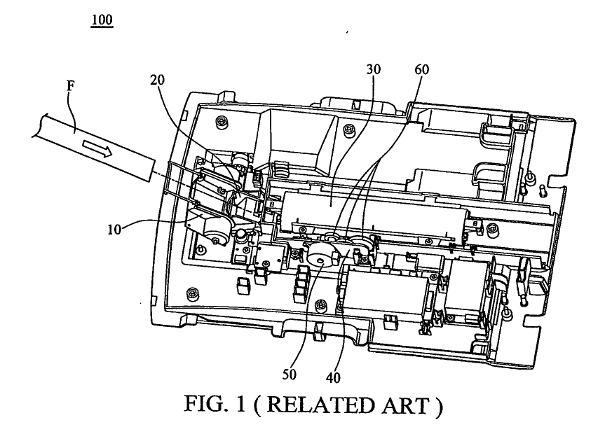

FIG. 2a is a perspective view of a scanner according to an embodiment of the invention showing a film being fed;

FIG. 2b is a perspective view of a scanner according to an embodiment of the invention showing a film is ejected;

FIG. 3 is a perspective view of a distribution mechanism of a scanner according to an embodiment of the invention;

FIG. 4 is a schematic view of a distribution mechanism according to an embodiment of the invention showing a rocker arm swinging up;

FIG. 5 is a schematic view of a distribution mechanism according to an embodiment of the invention showing a rocker arm swinging down; and

FIG. 6 is an exploded perspective view of a distribution mechanism of a scanner according to an embodiment of the invention.

### DETAILED DESCRIPTION

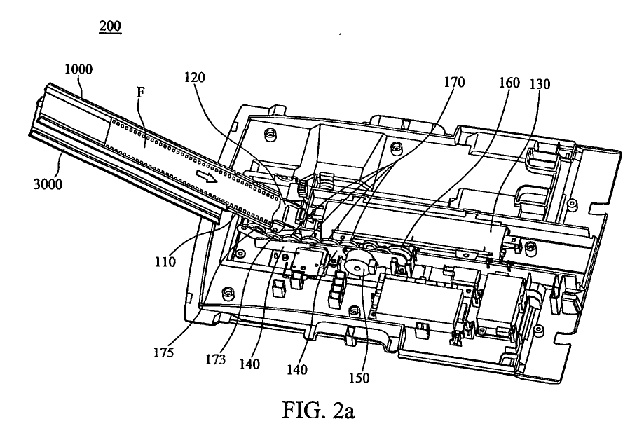

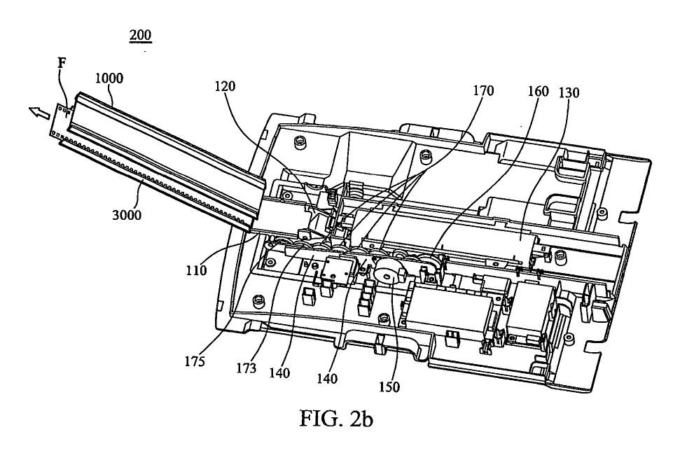

Referring to FIGS. 2a and 2b, a scanner 200 is provided with a feed cartridge 1000 and an ejection cartridge 3000. A film F placed in the feed cartridge 1000 is conveyed into a scan module 130 via a trail 110 and a track 120. A draw mechanism (not shown) within the scan module 130 is driven by a motor 150 and a plurality of engaged gears 160 on a frame 140 to draw the film F into the scan module 130. When the scan is completed, the film F is ejected out of the scan module 130 by the draw mechanism. At the same time, the trail 110 driven by the motor 150 and a plurality of engaged gears 170 swings down to link with the ejection cartridge 3000. The scanned film F is conveyed to the ejection cartridge 3000 via the track 120 and the trail 110. The motor 150 reverses to swing the trail 110 up so as to link the feed cartridge 1000, and the next film is fed thereto. Thus, a scanning procedure for multiple films is accomplished by repeated feeding and ejection. The structure of a distribution mechanism driving the trail 110 swinging up and down is described in the followings.

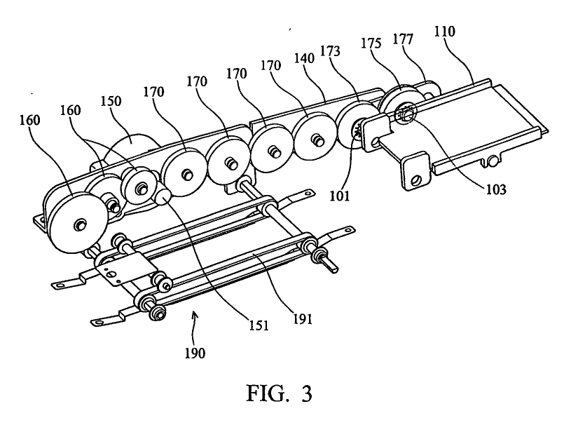

FIG. 3 is a perspective view of the distribution mechanism of the embodiment. In FIG. 3, power from a motor shaft 151 is transmitted in two directions via two groups of gears 160 and 170 respectively. A motor 150 drives a convey belt 191 of the draw mechanism 190 within the scan module 130 via gears 160. The motion of the conveyor belt 191 draws film in or ejects film from the scan module 130. Power from the motor 150 is transmitted to a first gear 173 pivoted on a first shaft 101 on the frame 140 via gears 170. A rocker arm 177 is pivoted on the first shaft 101 and positioned between the first gear 173 and the frame 140. The rocker arm 177 has a second shaft 103 on which a second gear 175 is pivoted. The second gear 175 abuts the rocker arm 177 so tightly that the second gear 175 drives the rocker arm 177 swinging around the first shaft 101 up and down when the second gear 175 is rotated by the first gear 173. The rocker arm 177 swings up to an upper dead point or down to a lower dead point, whereby the trail 110 joining the rocker arm 177 swings up to link the feed cartridge 1000 or down to link the ejection cartridge 3000.

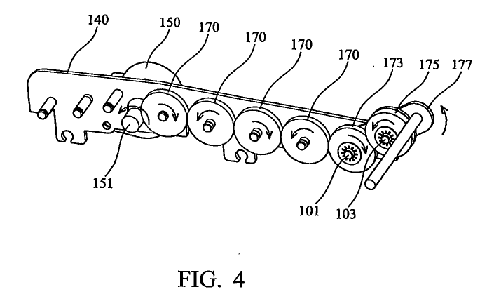

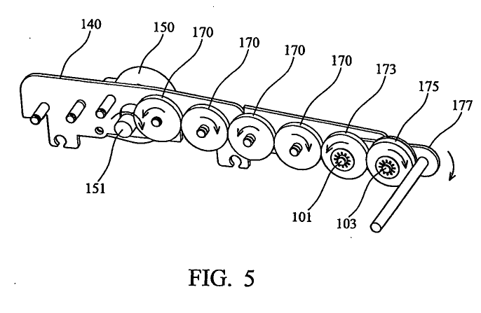

FIGS. 4 and 5 show the rocker arm 177 swinging up and down respectively. For the sake of clarity, the gears 160 and the draw mechanism 190 are omitted. In FIG. 4, motor shaft 151 rotates clockwise to rotate the first gear 173 counterclockwise via the gears 170 so as to rotate the second gear 175 clockwise and swing the rocker arm 177 up. In FIG. 5, motor shaft 151 rotates counterclockwise to rotate the first gear 173 clockwise via the gears 170 so as to rotate the second gear 175 counterclockwise and swing the rocker arm 177 down.

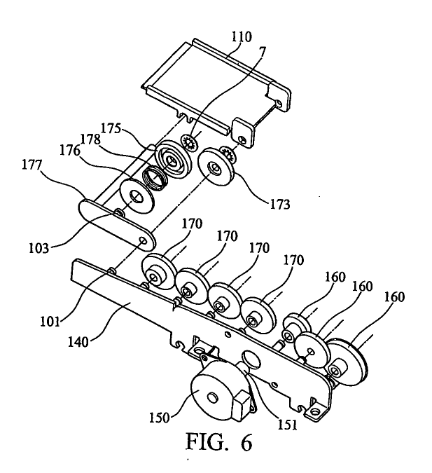

FIG. 6 is an exploded perspective view of the distribution mechanism. In FIG. 6, a friction element, such as a woolpad wheel 176, is disposed between the second gear 175 and the rocker arm 177, and a spring 178 is disposed between the woolpad wheel 176 and the second gear 175. A fastener 7 joins the second gear 175, the woolpad wheel 176 and the spring 178 on the second shaft 103 and makes them abut the rocker arm 177 tightly. When the second gear 175 is rotated by the first gear 173, as the friction between the second gear 175 and the woolpad wheel 176 is equal to the friction between the woolpad wheel 176 and the rocker arm 177, the second gear 175 swings the rocker arm 177 via the woolpad wheel 176. When the rocker arm 177 swings to the upper dead point or the lower dead point and stops, the friction between the second gear 175 and the woolpad wheel 176 is greater than the friction between the woolpad wheel 176 and the rocker arm 177, and the woolpad wheel 176 driven by the second gear 175 continues rotating with respect to the stopped rocker arm 177, whereby the driving force is released from the rocker arm 177 to avoid damage to the motor 150.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A distribution mechanism for a scanned object, comprising:
a frame;
a rocker arm pivoted on the frame to swing between an upper dead point and a lower dead point;
a first gear pivoted on the frame;
a second gear pivoted on the rocker arm and engaging the first gear; and
a friction element pivoted on the rocker arm and abutting the second gear and the rocker arm, wherein when the first gear rotates the second gear, the second gear rotates the rocker arm upward or downward selectively via the friction element, and when the rocker arm swings up to the upper dead point or down to the lower dead point, the second gear maintains rotation of the friction element with respect to the rocker arm.

2. The distribution mechanism as claimed in claim 1 further comprising a spring between the second gear and the friction element to make the friction element tightly abut the second gear and the rocker arm.

3. The distribution mechanism as claimed in claim 1 further comprising a trail, joining the rocker arm and swinging with the rocker arm.

4. The distribution mechanism as claimed in claim 1 further comprising a motor disposed on the frame to drive the first gear.

5. The distribution mechanism as claimed in claim 4 further comprising a plurality of engaged gears pivoted on the frame and joined with the motor and the first gear whereby the engaged gears are driven by the motor to rotate the first gear.

6. The distribution mechanism as claimed in claim 1, wherein the friction element is a woolpad wheel.

7. The distribution mechanism as claimed in claim 1, wherein the rocker arm further comprises a shaft extending through centers of the friction element and the second gear.

8. A scanner, comprising:
a frame;
a rocker arm pivoted on the frame and swinging up to an upper dead point or down to a lower dead point;
a first gear pivoted on the frame;
a second gear pivoted on the rocker arm and engaging the first gear; and
a friction element pivoted on the rocker arm and abutting the second gear and the rocker arm; and
a trail bearing the scanned object, joining the rocker arm and capable of swinging with the rocker arm, wherein when the first gear rotates the second gear, the second gear rotates the rocker arm upward or downward selectively via the friction element, and when the rocker arm swings up to the upper dead point or down to the lower dead point, the second gear maintains rotation of the friction element with respect to the rocker arm.

9. The scanner as claimed in claim 8 further comprising a spring between the second gear and the friction element to make the friction element tightly abut the second gear and the rocker arm.

10. The scanner as claimed in claim 8 further comprising a motor disposed on the frame to drive the first gear.

11. The scanner as claimed in claim 8 further comprising a plurality of gears pivoted on the frame and joined with the motor and the first gear whereby the engaged gears are driven by the motor to rotate the first gear.

12. The scanner as claimed in claim 8 further comprising a feed cartridge disposed at the upper dead point capable of linking the trail and an ejection cartridge disposed at the lower dead point capable of linking the trail.

13. The scanner as claimed in claim 8, wherein the friction element is a woolpad wheel.

14. The scanner as claimed in claim 8, wherein the rocker arm further comprises a shaft extending through centers of the friction element and the second gear.

15. The scanner as claimed in claim 8 further comprising a scan module, wherein when the rocker arm rotates up to the upper dead point, the scanned object is sent to the scan module, and when the rocker arm rotates down to the lower point, the scanned object is removed from the scan module.
